(19) United States
(12) Patent Application Publication
(10) Pub. No.: US 2023/0112701 A1
(43) Pub. Date: Apr. 13, 2023

(54) MODULAR WORKSTATION

(71) Applicant: Purem GmbH, Neunkirchen (DE)

(72) Inventors: Sascha Borm, Ottweiler (DE); Andreas Klee, Namborn (DE)

(21) Appl. No.: 18/046,007

(22) Filed: Oct. 12, 2022

(30) Foreign Application Priority Data
Oct. 12, 2021 (DE) 10 2021 126 366.2

(51) Int. Cl. B23Q 1/26

(52) U.S. Cl. CPC B23Q 1/26

(57) ABSTRACT

A modular workstation includes a work module support having at least one work module support fastening region for fixing a work module to the work module support, a plurality of the work modules having a work module fastening region for detachable fixing to a work module support fastening region of the work module support. At least one of the work modules includes a work carrier movable in at least one movement mode and a work carrier drive for driving the work carrier for movement in the at least one movement mode.

### CROSS REFERENCE TO RELATED APPLICATION

This application claims priority of German patent application no. 10 2021 126 366.2, filed Oct. 12, 2021, the entire content of which is incorporated herein by reference.

### TECHNICAL FIELD

The present disclosure relates to a modular workstation.

### BACKGROUND

For the assembly of exhaust systems or components of exhaust systems for internal combustion engines of motor vehicles, components to be connected to one another by welding are fixed via workpiece carriers carrying them to workstation work carriers movable in at least one movement mode, for example a rotary movement mode, and are positioned in such a way by movement of a respective work carrier that, for a welding robot for example, there is access to regions to be welded.

### SUMMARY

It is an object of the present disclosure to provide a workstation, in particular for carrying out welding operations during the assembly of exhaust systems or components of exhaust systems for internal combustion engines of motor vehicles, with extended possibilities of use.

According to the disclosure, this object is achieved by a modular workstation. This modular workstation includes:
a work module support having at least one work module support fastening region for fixing a work module to the work module support,
a plurality of, preferably different, work modules having a work module fastening region for detachable fixing to a work module support fastening region of the work module support, wherein at least one of the work modules includes a work carrier movable in at least one movement mode and a work carrier drive for driving the work carrier for movement in the at least one movement mode.

By virtue of the modular configuration of the workstation, in which the drive carrier drive required for generating a movement of a work carrier is integrated in a respective work module, there is the possibility of fixing various work modules, which are particularly suitable for different work processes, on the work module support in a simple manner without it being necessary to couple drive components to one another or to decouple them from one another when a work module is removed from the work module support. The workstation can thus be set up quickly for a wide variety of work processes.

In order to be able to carry out different work processes simultaneously with the workstation constructed according to the disclosure, it is proposed that at least two work module support fastening regions for fixing in each case one work module are provided on the work module support.

In order to avoid mutual interference during the simultaneous execution of various or several work processes, it is advantageous if at least two work module support fastening regions are provided on mutually opposite sides of the work module support. For variable connection of work modules to the work module support, it is proposed that at least two work module support fastening regions are substantially identical to one another.

At least one of the work modules can be a single-axis work module, wherein the work carrier of the single-axis work module can be rotated about an axis of rotation, and the work carrier drive of the single-axis work module includes a rotary drive for driving the work carrier in rotation about the axis of rotation.

For a structure which is simple to implement, the rotary drive can here include a rotary drive motor, which can preferably be operated electrically.

Furthermore, at least one of the work modules can be a two-axis work module, wherein the work carrier of the two-axis work module can be rotated about an axis of rotation and can be pivoted about a pivot axis, and wherein the work carrier drive of the two-axis work module includes a rotary drive for driving the work carrier in rotation about the axis of rotation and a pivot drive for driving the work carrier to pivot about the pivot axis.

For a construction which is simple to implement, it is possible here too for the rotary drive to include a rotary drive motor, which can preferably be operated electrically, or/and the pivot drive can include a pivot drive motor, which can preferably be operated electrically.

For the possibility of carrying out defined movement processes, it is proposed that the pivot axis is not parallel to the axis of rotation, or/and that the pivot axis intersects the axis of rotation, preferably at an angle of about 90°.

The two-axis work module can include:
a rotary subassembly, wherein the rotary subassembly includes the rotary drive and the work carrier,
a pivoting subassembly, wherein the pivoting subassembly includes the work module fastening region and the pivot drive.

In this case, the rotary subassembly can be supported pivotably on the pivoting subassembly by the pivot drive for pivoting about the pivot axis.

In order to be able to mount different work modules on different work module support fastening regions as desired, all the work modules can have substantially identical work module fastening regions.

For stable positioning of workpieces to be processed on the workstation according to the disclosure during a work process to be carried out, it is advantageous if a counterbearing unit is provided in association with at least one work module support fastening region. In this case, the counterbearing unit can have a counterbearing support, which can be rotated about a counterbearing axis of rotation, wherein the counterbearing axis of rotation of the at least one counterbearing unit corresponds substantially to the axis of rotation of the work module when this work module is fixed to the work module support fastening region assigned to it.

Further increased variability in the use of the workstation according to the disclosure can be achieved in that at least one counterbearing unit provided in association with a work module support fastening region can be moved preferably in the direction of a counterbearing axis of rotation with respect to the associated work module support fastening region.

For mounting one or more workpieces on a work carrier, at least one workpiece carrier subassembly can be provided, wherein the at least one workpiece carrier subassembly has a first fastening region for mounting on a work carrier and a workpiece receiving region for receiving at least one workpiece.

In this case, stable mounting can be promoted if at least one workpiece carrier subassembly includes a second fastening region for mounting on a counterbearing unit.

In order to be able to use a workpiece carrier subassembly in combination with work modules of different types, it is proposed that at least one workpiece carrier subassembly, which has a first fastening region and a second fastening region, includes a first subassembly part, which has the first fastening region, and a second subassembly part, which is to be connected detachably to the first subassembly part and provides the second fastening region.

### BRIEF DESCRIPTION OF THE DRAWINGS

The invention will now be described with reference to the drawings wherein:

FIG. 1 shows a perspective view of a modular workstation;

FIG. 2 shows a work module support of the workstation of FIG. 1 with two work modules fixed thereto;

FIG. 3 shows a plan view of the work module support of FIG. 2;

FIG. 4 shows a perspective view of the work module support of the workstation of FIG. 1;

FIG. 5 shows a side view of the work module support of FIG. 4;

FIG. 6 shows a perspective view of a single-axis work module of the workstation of FIG. 1;

FIG. 7 shows a perspective view of a two-axis work module of FIG. 1; and,

FIG. 8 shows a schematic illustration of the workstation of FIG. 1 in another application example.

### DESCRIPTION OF THE PREFERRED EMBODIMENTS

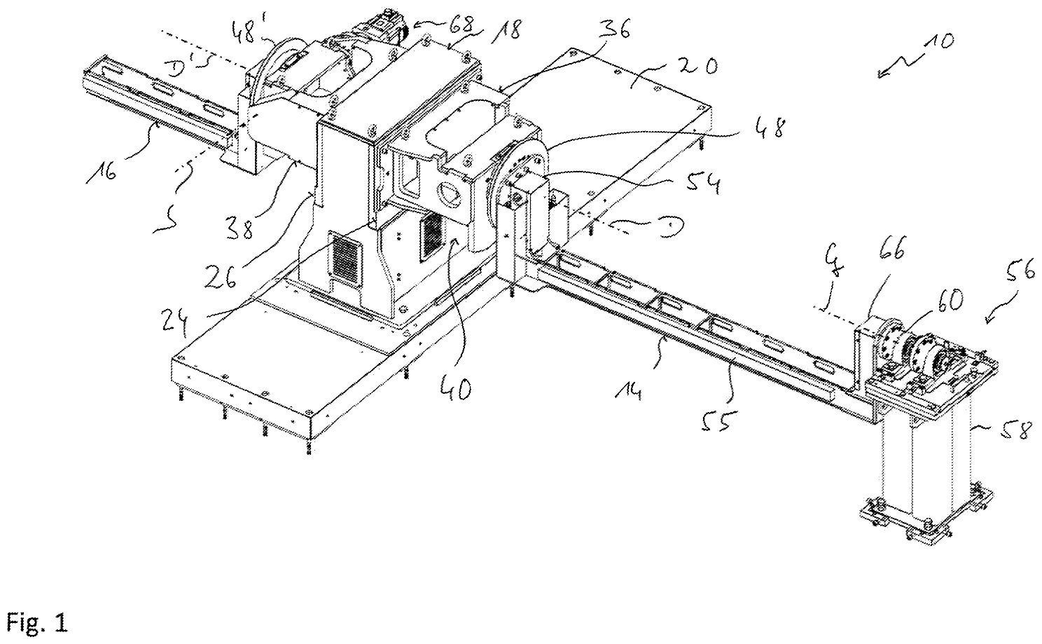

In FIG. 1, a modular workstation is denoted overall by 10. This workstation 10 can be used, for example, to weld exhaust systems or components for exhaust systems of internal combustion engines for motor vehicles. For this purpose, such components can be positioned on tool carrier assemblies 14 and 16, respectively. The tool carrier assemblies 14, 16 can then be moved in the workstation 10 in the manner described below into positions suitable for carrying out welding operations by welding robots, not illustrated in FIG. 1.

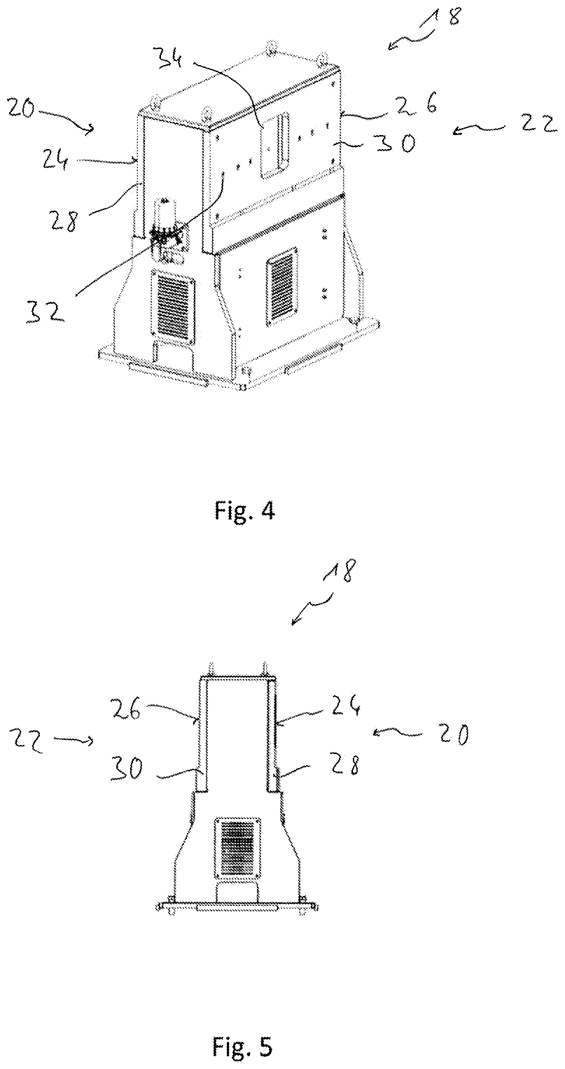

The modular workstation 10 includes a work module support 18 of box-type configuration, which is positioned in a fixed manner on a base 20 suitable for this purpose, for example by screwing. The work module support 18 is illustrated in FIGS. 4 and 5 and has a work module support fastening region 24, 26 on each of two sides 20, 22 of the work module support which are oriented away from one another. The work module support fastening regions 24, 26 can, for example, each have a support plate 28, 30, in which a plurality of internally threaded openings 32 is provided. Supply lines for work modules 36, 38 to be detachably fixed to the work module support 18 or to the work module support fastening regions 24, 26 of the latter can be passed through lead-through openings 34 in the support plates 28, 30.

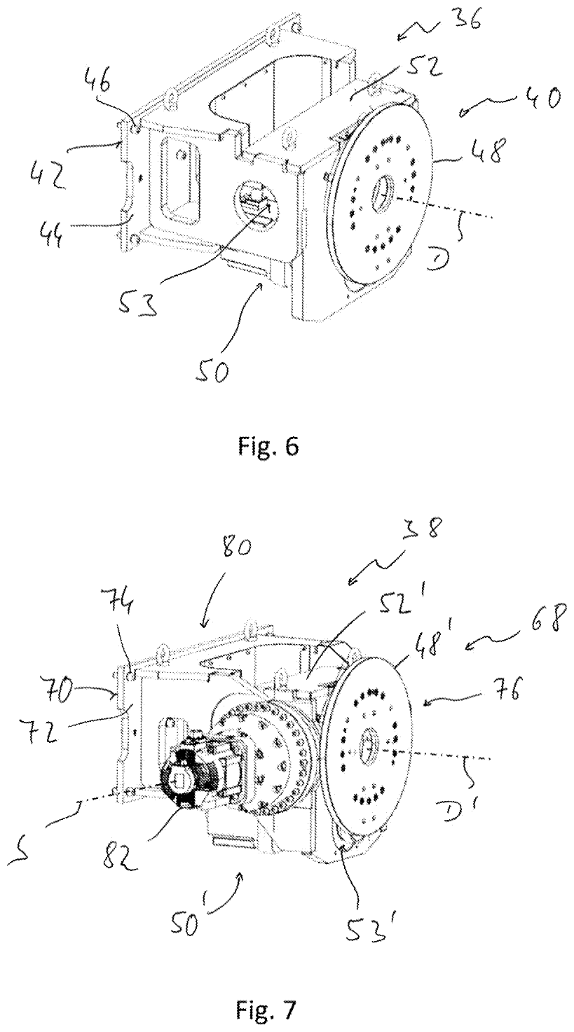

The work module 36, which is configured as a single-axis work module 40, is illustrated more clearly in FIG. 6. The single-axis work module 40 includes a work module fastening region 42, with which this can be fixed to each of the two work module support fastening regions 24, 26 of the work module support 18, the regions being of substantially identical configuration to one another. The work module fastening region 42 likewise includes a support plate 44, through which fastening screws 46 can be screwed into the internally threaded openings 32 of the work module support fastening region 24, 26 selected for fixing the single-axis work module 40. In the example illustrated in the figures, the single-axis work module 40 is fixed to the work module support fastening region 24 of the work module support 18.

The work module 36, which is configured as a single-axis work module 40, further includes a work carrier 48, which is of plate- or disk-type configuration, for example, and a work carrier drive 50, which is assigned to the work carrier and is accommodated in a drive box 52. The work carrier drive 50 of the single-axis work module 40 has a rotary drive 53 with an electrically excitable rotary drive motor, via which the work carrier 48 can be driven in rotation about an axis of rotation D, for example, in an unlimited angular range. Since the work carrier drive 50 accommodated in the drive box 52 is otherwise supported immovably on the single-axis work module 40, the work carrier 48 can be moved only in a rotary-movement mode, that is, is rotatable about the axis of rotation D.

When a workpiece carrier subassembly 14 is fixed by a first fastening region 54, for example by screwing to the work carrier 48 of the single-axis work module 40, the workpiece carrier 54 or its workpiece receiving region 55 can be rotated about the axis of rotation D when the rotary drive motor is excited, as a result of which the workpieces W carried on the workpiece carrier subassembly 14 are also rotated or moved about the axis of rotation D and can thus be positioned in a position which is suitable for access, by a welding robot for example.

In order in this case to ensure a defined movement or positioning of the workpiece carrier subassembly 14, which is of comparatively long construction in the direction of the axis of rotation D, a counterbearing unit 56 is provided in association with the work module support fastening region 24. This includes a support column 58, which is fixed in a stationary manner, for example, on a base and in the upper region of which a counterbearing support 60 is arranged such that it can rotate about a counterbearing axis of rotation G. The workpiece carrier subassembly 14 is fixed to the counterbearing support 60 by a second fastening region 62 thereof, for example by screwing. The counterbearing axis of rotation D corresponds substantially to the axis of rotation D, so that, driven by the work carrier drive 50, the workpiece carrier subassembly 14 can be rotated or moved in its two fastening regions 54, 66 about the axis of rotation D and the counterbearing axis of rotation G.

The work module 38, which is detachably fixed to the work module support fastening region 26 in the illustrated embodiment of a modular workstation 10, is configured as a two-axis work module 68. The two-axis work module 68 includes a work module fastening region 70, which is of substantially identical configuration to the work module fastening region 42 of the single-axis work module 40 and has a support plate 72, with which the two-axis work module 68 can be detachably fixed to each of the work module support fastening regions 24, 26 by fastening screws 74.

The two-axis work module 68 includes a rotary subassembly designated in general by 76. This includes the rotary drive 53′, accommodated in the drive box 52′, for the work carrier 48′, which is rotatable about the axis of rotation D in the rotary-movement mode.

The two-axis work module 68 further has a pivoting subassembly 80. The pivoting subassembly 80 includes the work module fastening region 70 and an electrically excitable pivot drive motor supported thereon. Via the pivot drive motor, which essentially provides a pivot drive 82, the rotary subassembly 76 can be driven in a pivoting movement mode for pivoting about a pivot axis S. The pivot axis S and the axis of rotation D′ are preferably substantially orthogonal to one another and, in the illustrated embodiment, intersect in a region which lies outside the tool carrier subassembly 14 in the direction of the axis of rotation D′ and thus also outside each workpiece carried on the latter. The two-axis work module 68 is therefore configured as a two-axis turner. In a different structural configuration, the axis of rotation D′ and the pivot axis S could intersect in the axial region in which the workpiece carrier subassembly 14 and thus one or more workpieces W carried on the workpiece receiving region 55 are positioned in the direction of the axis of rotation D′. In this case, the two-axis work module 68 is configured as a two-axis orbital turner.

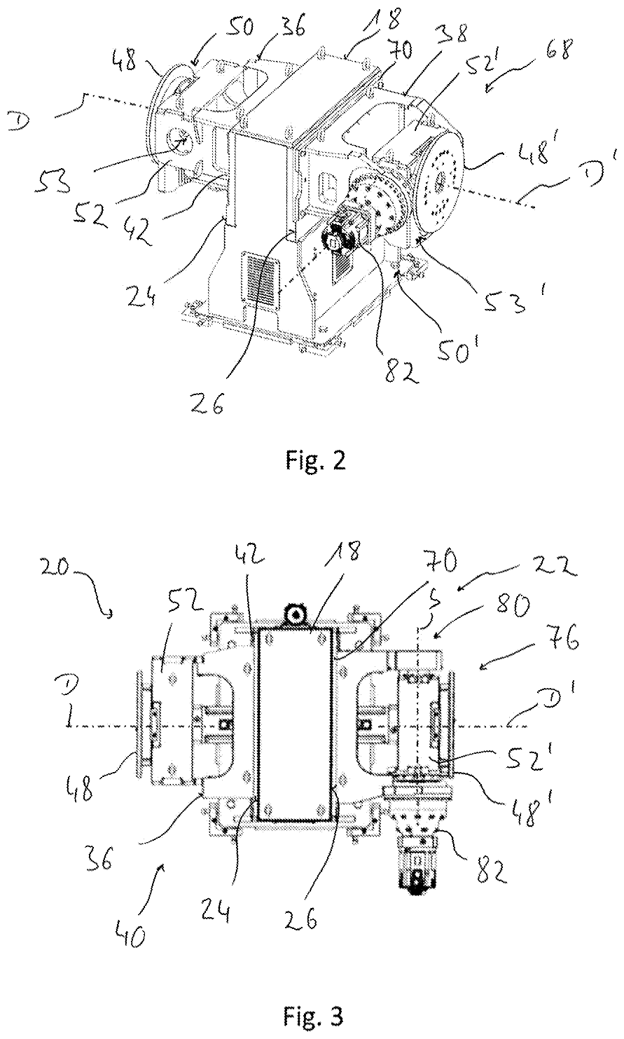

When the rotary subassembly 76 is pivoted about the pivot axis S, the pivot axis D′ changes its spatial position, it being possible for the latter to be oriented obliquely to the horizontal, for example, for example, starting from the substantially horizontal positioning of the pivot axis D′ illustrated in FIGS. 1 and 2, or to be positioned substantially at an angle of 90° with respect to the horizontal. In this position of the axis of rotation D′, the workpiece carrier subassembly 16 carried on the work carrier 48′ can then be rotated about the axis of rotation D′ for suitable access, for example, of a welding robot. When the position of the workpiece carrier subassembly 16 then achieved has been brought about, the rotary drive motor 53′ of the rotary subassembly 76 and the pivot drive 82 of the pivoting subassembly 80 cooperate, which in this embodiment of the two-axis work module 68 provide the drive carrier drive 50′.

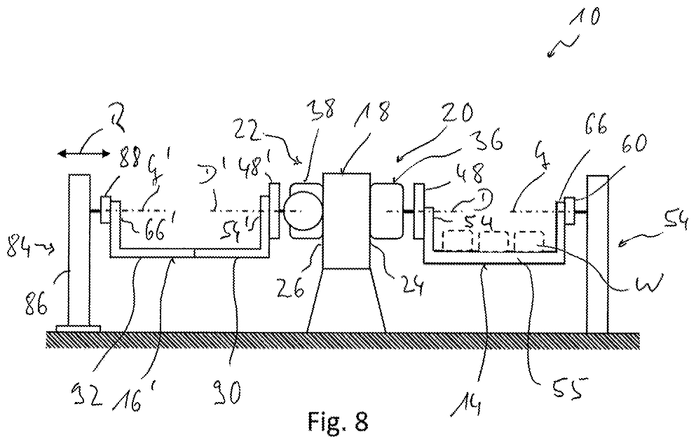

In the expanded embodiment of the modular workstation 10 shown in FIG. 8, a counterbearing unit 84 is also provided in association with the work module support fastening region 26. This too has a support column 86, on which a counterbearing support 88 is supported so as to be rotatable about a counterbearing axis of rotation G′. In this embodiment, the workpiece carrier subassembly 16 provided in association with the two-axis work module 68 includes a first subassembly part 90 fixed to the work carrier 48′, for example, by screwing, and a second subassembly part 92 fixed to the counterbearing support 88, for example, by screwing. In their adjoining region 94, the two subassembly parts 90, 92 are detachably connected to one another, for example, by screwing, so that, in the embodiment illustrated, workpiece carrier subassembly 16 has a structure which corresponds substantially to the structure of workpiece carrier subassembly 14. Via the first fastening region 54′ provided on the first subassembly part 90, the workpiece carrier subassembly 16 is fixed to the work carrier 48. Via the second fastening region 66′ provided on the second subassembly part 92, the workpiece carrier subassembly 16 is fixed to the counterbearing support 88.

In this embodiment of the modular workstation 10, the two-axis work module 68 can fundamentally only be operated in the rotary operating mode, in which the workpiece carrier subassembly 16 can be driven in rotation about the axis of rotation D′ or the counterbearing axis of rotation G′. Pivoting of the rotary subassembly 76 about the pivot axis S is excluded.

In order to allow this pivoting in this configuration of the workstation 10, the counterbearing unit 84 can be moved in a direction R toward and away from the work module support 18. The direction R corresponds substantially to the direction of the axis of rotation D′ if the latter is oriented substantially horizontally.

Starting from the state illustrated in FIG. 8, the two subassembly parts 90, 92 can be detached from one another in their adjoining region 94, and subassembly part 92 can then be moved, together with the counterbearing unit 84, in the direction R away from the first subassembly part 90 or the two-axis work module 68 carrying the latter, for example to an extent of 0.2 to 0.5 m. The first subassembly part 90 of the workpiece carrier subassembly 16 can then be pivoted about the pivot axis S, being driven by the pivot drive 82, in order to bring workpieces carried thereon into a suitable position.

It is clear from the preceding description of the modular workstation 10 that all the components or system regions provided for moving the work carriers 48 and 48′ of the work modules 36, 38, that is, in particular, the work carrier drive 50, 50′ provided in a respective work module 36, 38, form part of a respective module and are not completely or partially integrated into the work module support 18. When attaching a respective work module 36, 38 to the work module support 18, it is therefore not necessary to establish any mechanical connections. It is merely necessary to connect the respective work drives 50 and 50′ by way of corresponding line connections to a control device or an energy source, that is, for example, a power network, in order to conduct the electrical energy required for operating the work carrier drives 50, 50′ to the respective rotary drive motors and to the pivot drive motor. If necessary, a connecting line can also be connected through a respective through-opening 34 to the work module 36 or 38 to be connected to a respective work module support fastening region 24, 26 in order to supply operating media, such as oil or lubricant, for example.

Since, in the case of the work module support 18, the work module support fastening regions 24, 26 provided thereon are of substantially identical construction to one another, any of the work modules 36, 38, which are constructed with likewise identical work module fastening regions 42, 70, can be fixed to either of the work module support fastening regions 24, 26 by screwing and can also be removed therefrom again. This makes it possible to carry out a work process on the modular workstation 10 in association with each work module support fastening region 24, 26, using a work module 36 or 38 which is in each case particularly suitable for this purpose. Of course, it is also possible for work modules of the same configuration to be arranged on both work module support fastening regions 24, 26.

A further embodiment of a work module which can be used in the modular workstation could include a work carrier which is supported in a fixed manner on the work module fastening region, that is, a work carrier which is not assigned a work carrier drive and which ultimately only permits a substantially rigid connection of a workpiece carrier subassembly to such a work module or to the work module support. Such a configuration can be used, in particular, when a movement of the workpiece carrier subassembly carrying the workpieces to be processed is not necessary for the suitable execution of a work process, for example for welding components of an exhaust system.

It is understood that the foregoing description is that of the preferred embodiments of the invention and that various changes and modifications may be made thereto without departing from the spirit and scope of the invention as defined in the appended claims.

What is claimed is:

1. A modular workstation comprising:
a work module;
a work module support having at least one work module support fastening region for fixing said work module to said work module support;
a plurality of work modules having respective work module fastening regions for detachably fixing to said at least one work module support fastening region of said work module support; and,
at least one of said plurality of work modules having a work carrier movable in at least one movement mode and a work carrier drive for driving said work carrier for movement in said at least one movement mode.

2. The workstation of claim 1, wherein said work module support has at least two work module support fastening regions for fixing respective ones of said work modules.

3. The workstation of claim 2, wherein at least one of the following applies:
i) at least said two work module support fastening regions are provided on mutually opposite sides of said work module support; and,
ii) said at least two of said work module support fastening regions are identical to one another.

4. The workstation of claim 1, wherein:
at least one of said work modules is a single-axis work module;
the work carrier of said single-axis work module is rotatable about an axis of rotation (D); and,
said work carrier drive of said single-axis work module includes a rotary drive for driving said work carrier in rotation about said axis of rotation (D).

5. The workstation of claim 4, wherein said rotary drive includes a rotary drive motor.

6. The workstation of claim 4, wherein said rotary drive includes a rotary drive operated electrically.

7. The workstation of claim 1, wherein:
at least one of said work modules is a two-axis work module;
said two-axis work module has a work carrier rotatable about an axis of rotation (D′) and is pivotable about a pivot axis (S); and,
said two-axis work module has a work carrier drive including a rotary drive for driving the work carrier in rotation about the axis of rotation (D′) and a pivot drive for driving the work carrier to pivot about said pivot axis (S).

8. The workstation of claim 7, wherein at least one of the following applies:
i) said rotary drive includes a rotary drive motor; and,
ii) said pivot drive includes a pivot drive motor.

9. The workstation of claim 7, wherein at least one of the following applies:
i) said pivot axis (S) is non-parallel to said axis of rotation (D′); and,
ii) said pivot axis (S) intersects the axis of rotation (D′).

10. The workstation of claim 9, wherein said pivot axis (S) intersects said axis of rotation (D′) at an angle of 90 degrees.

11. The workstation of claim 7, wherein:
said two-axis work module includes a rotary subassembly;
said rotary subassembly includes said rotary drive and said work carrier;
said two-axis work module further includes a pivoting subassembly;
said pivoting subassembly includes a work module fastening region and a pivot drive; and,
said rotary subassembly is supported pivotably on said pivoting subassembly by said pivot drive for pivoting about said pivot axis (S).

12. The workstation of claim of claim 1, wherein all of said work modules have identical work module fastening regions.

13. The workstation of claim 1, further comprising at least one counterbearing unit provided in association with at least one of said work module support fastening regions.

14. The workstation of claim 13, wherein:
said counterbearing unit defines an axis of rotation (D, D′) and has a counterbearing support which is rotatable about a counterbearing axis of rotation (G, G′); and,
said counterbearing axis of rotation (G, G′) of said at least one counterbearing unit corresponds to said axis of rotation (D, D′) of the work module when this work module is fixed to said work module support fastening region assigned thereto.

15. The workstation of claim 13, wherein said at least one counterbearing unit is provided in association with a work module support fastening region and is movable in the direction of said counterbearing axis of rotation (G′) with respect to the associated work module support fastening region.

16. The workstation of claim 1, further comprising at least one workpiece carrier subassembly including a first fastening region for mounting on a work carrier and a workpiece receiving region for receiving at least one workpiece (W).

17. The workstation of claim 16, wherein said at least one workpiece carrier subassembly includes a second fastening region for mounting on a counterbearing unit.

18. The workstation of claim 17, wherein said at least one workpiece carrier subassembly includes: a first fastening region, a second fastening region, a first subassembly part having said first fastening region, and a second subassembly part which is connectable detachably to said first subassembly part and provides said second fastening region.
